(19) United States
(12) Patent Application Publication
(10) Pub. No.: US 2016/0076303 A1
(43) Pub. Date: Mar. 17, 2016

(54) Winding Wheel Assembly

(71) Applicant: Tai Ping Liu, TAICHUNG (TW)

(72) Inventor: Tai Ping Liu, TAICHUNG (TW)

(21) Appl. No.: 14/484,187

(22) Filed: Sep. 11, 2014

(51) Int. Cl. E06B 9/323

(52) U.S. Cl. CPC E06B 9/323

(57) ABSTRACT

A winding wheel assembly includes a casing, a worm wheel, a worm, a pulley, a base and a cover unit. The casing includes a rod formed thereon and two barbs formed thereon. The worm wheel is inserted in the casing. The worm is engaged with the worm wheel. The pulley is connected to the worm and located out of the casing. The base is connected to the casing and located below the pulley. The cover unit includes a canopy for covering the pulley, a buckle engaged with the rod, and two barbs engaged with barbs of the casing.

### BACKGROUND OF INVENTION

1. Field of Invention

The present invention relates to a winding wheel assembly for a curtain and, more particularly, to a cover unit of a winding wheel assembly.

2. Related Prior Art

As disclosed in U.S. Pat. No. 6,761,204, a winding wheel assembly includes an anchor dock 1, an axle 2, a pulley 3, an anchor lug 4 and a base 5. The anchor dock 1 includes two side boards 10 and 11. The side board 10 includes an opening 100, two arched notches 1000, two cavities 105 and 1060 and a stub shaft 102. The side board 11 includes an opening 110, two arched notches 1000, two wedge rods 115 and 116 and a stub shaft 112. The side boards 10 and 11 are joined. The wedge rods 115 and 116 are inserted in the cavities 105 and 1060 to precisely position the side board 10 relative to the side board 11. The axle 2 is formed with two struts 21. The axle 2 is inserted in the anchor dock 1. The struts 21 are inserted in the openings 100 and 110 to render the axle 2 rotatable in the anchor dock 1. A worm 30 is formed on a side of the pulley 3. Two stems 300 are formed on the worm 30. The worm 30 is inserted in the anchor dock 1. Each arched notch 1000 of the side board 10 matches with a corresponding arched notch 1000 of the side board 11 to form a circular opening for receiving a corresponding stem 300 to render the worm 30 rotatable in the anchor dock 1. The stub shafts 102 and 112 are inserted in a barrel 50 formed on the base 5 to render the base rotatable relative to the anchor dock 1. The anchor lug 4 includes a cover 42, a tubular element 40 formed at an edge of the cover 42, and a support block 41 formed at an opposite edge of the cover 42. A bolt 400 is inserted in the tubular element 40 and the side boards 10 and 11 to render the anchor lug 4 rotatable on the anchor dock 1. The use of the bolt 400 to rotationally connect the anchor lug 4 to the anchor dock 1 is however inconvenient because at least one tool is required to rotate the bolt 400.

Therefore, the present invention is intended to obviate or at least alleviate the problems encountered in prior art.

### SUMMARY OF INVENTION

It is the primary objective of the present invention to provide a winding wheel assembly that can easily be assembled.

To achieve the foregoing objective, the winding wheel assembly includes a casing, a worm wheel, a worm, a pulley, a base and a cover unit. The casing includes a rod formed thereon and two barbs formed thereon. The worm wheel is inserted in the casing. The worm is engaged with the worm wheel. The pulley is connected to the worm and located out of the casing. The base is connected to the casing and located below the pulley. The cover unit includes a canopy for covering the pulley, a buckle engaged with the rod, and two barbs engaged with barbs of the casing.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a winding wheel assembly according to the preferred embodiment of the present invention;

FIG. 2 is a side view of the winding wheel assembly shown in FIG. 1;

FIG. 3 is an exploded view of the winding wheel assembly shown in FIG. 1; and

FIG. 4 is a cross-sectional view of the winding wheel assembly shown in FIG. 1.

### DETAILED DESCRIPTION OF PREFERRED EMBODIMENT

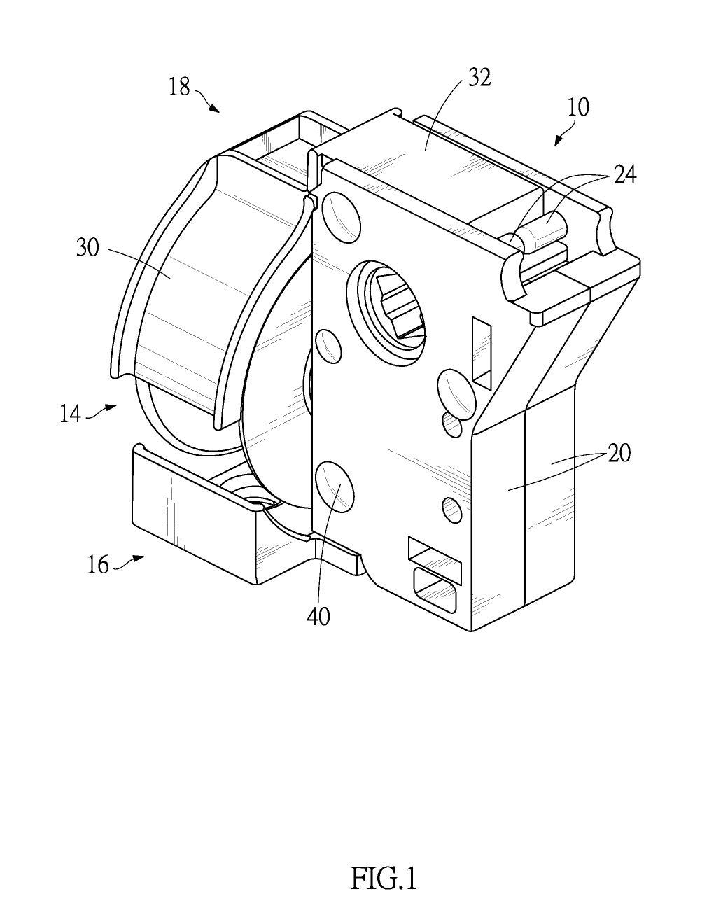

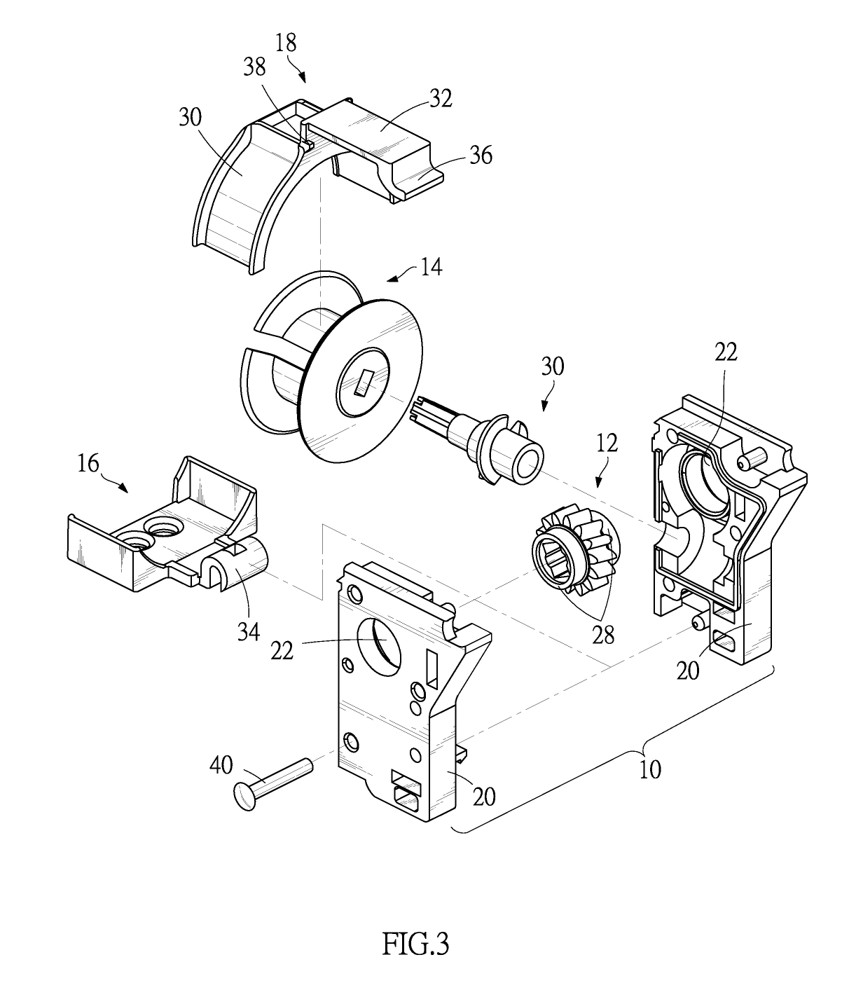

Referring to FIGS. 1 to 4, there is a winding wheel assembly according to the preferred embodiment of the present invention. The winding wheel assembly includes a casing 10, a worm wheel 12, a pulley 14, a base 16 and a cover unit 18.

The casing 10 includes two side boards 20 joined together. Each side board 20 is formed with an opening 22, a rod 24 and a barb 26. The rod 24 includes a free end. The free end of the rod 24 of one of the side boards 20 is preferably in contact with that of the rod 24 of the other side board 20. The barbs 26 extend parallel to each other.

The worm wheel 12 is inserted in the casing 10. Two axles 28 are formed on two opposite sides of the worm wheel 12. The axles 28 are inserted in the openings 22 to render the worm wheel 12 rotatable in the casing 10.

The pulley 14 is located out of the casing 10. A worm 30 is connected to the pulley 14. The worm 30 is rotationally inserted in the casing 10. The worm 30 is engaged with the worm wheel 12.

The base 16 includes a buckle 34 formed thereon. The buckle 34 is an arched element that extends for at least 180°.

The cover unit 18 includes a canopy 30, a lever 32, a buckle 36 and two barbs 38. The lever 32 extends from the canopy 30. The buckle 36 is formed at a free end of the lever 32. The buckle 36 is located near a lower face of the lever 32. The buckle 36 is formed with an arched upper face. The barbs 38 are formed on the canopy 30.

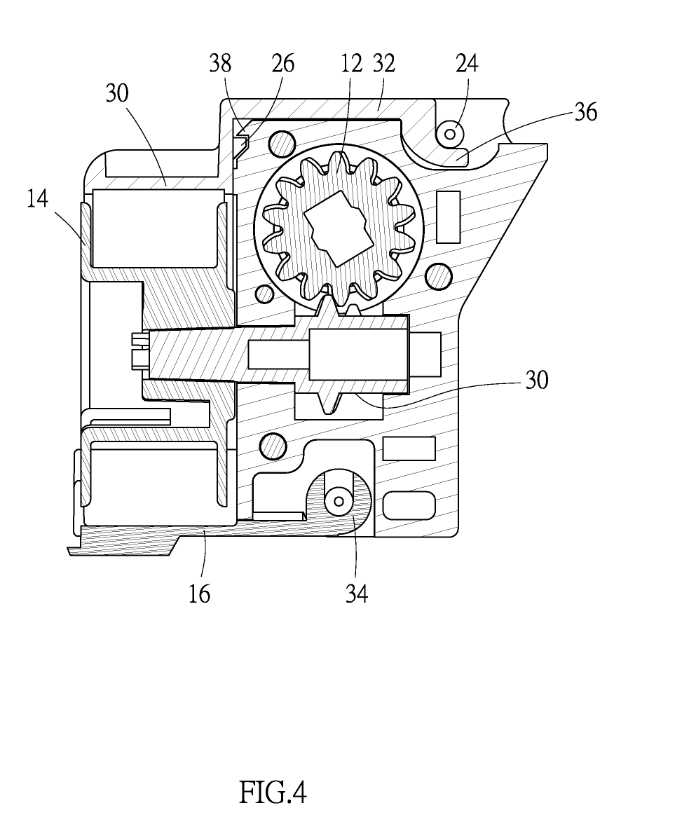

Referring to FIG. 4, the buckle 34 is engaged with a fastener 40 that is inserted in the side boards 20. The fastener 40 can be a rivet for example. Thus, the base 16 is pivotally connected to the casing 10. The base 16 is located below the pulley 14. The engagement of the buckle 34 with the fastener 40 is easy because it does not require any tool.

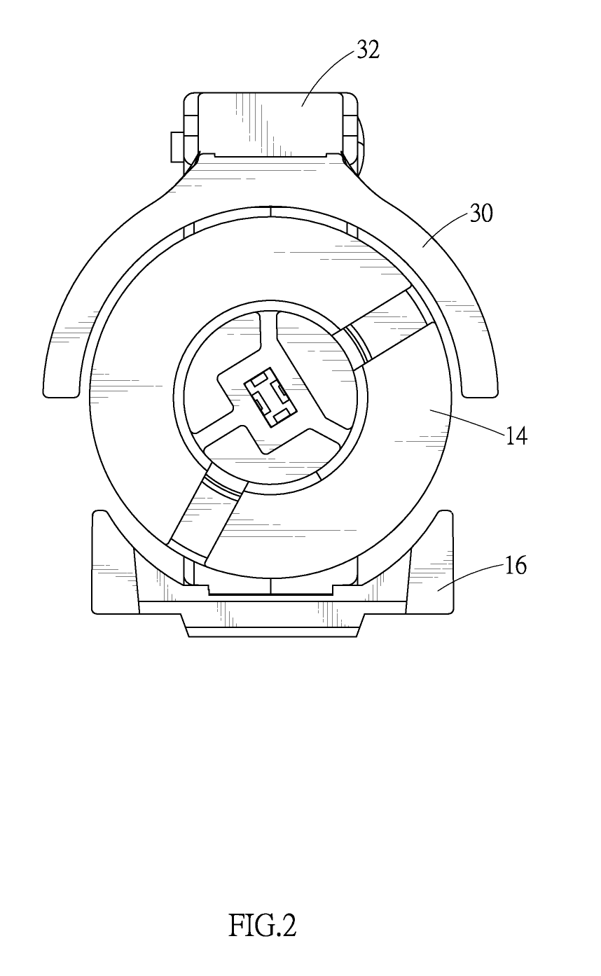

The cover unit 18 is connected to the casing 10. The buckle 36 is placed beneath the rods 24. The barbs 38 are engaged with the barbs 26. Thus, the cover unit 18 is retained on the casing 10. Referring to FIG. 2, the canopy 30 is located above the pulley 14. The engagement of the buckle 36 with the rods 24 and the engagement of the barbs 38 with the barbs 26 are easy because they do not require any tool.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A winding wheel assembly including:
a casing including a buckle-engaging unit formed thereon and two barbs formed thereon;
a worm wheel inserted in the casing;
a worm engaged with the worm wheel;
a pulley connected to the worm and located out of the casing;
a base connected to the casing and located below the pulley; and
a cover unit including a canopy for covering the pulley, a buckle engaged with the rod, and two barbs engaged with barbs of the casing.

2. The winding wheel assembly according to claim 1, wherein the cover unit includes a lever extending from the canopy, wherein the buckle is formed on the lever.

3. The winding wheel assembly according to claim 2, wherein the barbs of the cover unit are formed on the canopy.

4. The winding wheel assembly according to claim 1, wherein the casing includes two side boards joined together.

5. The winding wheel assembly according to claim 4, wherein each of the side boards includes a rod formed thereon, wherein the rods of the side boards abut against each other to form the buckle-engaging unit.

6. The winding wheel assembly according to claim 4, wherein each of the barbs of the casing is formed on a corresponding one of the side boards.

7. The winding wheel assembly according to claim 4, further including two axles formed on two opposite sides of the worm wheel, wherein each of the side boards includes an opening for receiving a corresponding one of the axles.

8. The winding wheel assembly according to claim 4, further including a fastener inserted in the side boards, wherein the base includes a buckle engaged with the fastener to pivotally connect the base to the casing.
